(19) United States
(12) Patent Application Publication
(10) Pub. No.: US 2024/0109503 A1
(43) Pub. Date: Apr. 4, 2024

(54) ATTACHMENT STRUCTURE FOR WIRING MEMBER

(71) Applicants: Sumitomo Wiring Systems, Ltd., Yokkaichi-shi (JP); Toyota Jidosha Kabushiki Kaisha, Toyota-shi (JP); Kabushiki Kaisha Toyota Jidoshokki, Kariya-shi (JP)

(72) Inventors: Tatsumi SATO, Yokkaichi-shi (JP); Kazuhiro Nishimura, Yokkaichi-shi (JP); Hirozumi Okaniwa, Yokkaichi-shi (JP); Tomohiko Tateishi, Yokkaichi-shi (JP); Tatsuya Aida, Kariya-shi (JP); Yuji Kawamoto, Kariya-shi (JP)

(73) Assignees: SUMITOMO WIRING SYSTEMS, LTD., Yokkaichi-shi (JP); TOYOTA JIDOSHA KABUSHIKI KAISHA, Toyota-shi (JP); KABUSHIKI KAISHA TOYOTA JIDOSHOKKI, Kariya-shi (JP)

(21) Appl. No.: 18/475,771

(22) Filed: Sep. 27, 2023

(30) Foreign Application Priority Data
Sep. 30, 2022 (JP) 2022-158286

(51) Int. Cl. B60R 16/02; B62D 25/14

(52) U.S. Cl. CPC B60R 16/0215; B62D 25/145

(57) ABSTRACT

The present disclosure relates to an attachment structure for attaching a wiring member to an instrument panel reinforcement, which is an attachment object, provided near an instrument panel. The wiring member includes a linear transmission member that transmits electricity or light, and a covering member that covers the linear transmission member. The wiring member attachment structure includes a rail member provided on the instrument panel reinforcement, and an insertion member that is provided on the covering member and inserted into the rail member. The wiring member is attached to the instrument panel reinforcement in a state in which the insertion member is inserted into the rail member.

### BACKGROUND

### 1. Field

The present disclosure relates to an attachment structure for a wiring member.

### 2. Description of Related Art

Japanese Laid-Open Patent Publication No. 2020-43087 describes an attachment structure for a wiring member. The wiring member includes a linear transmission member that transmits electricity or light, and a covering member that covers the linear transmission member. The wiring member is attached to an attachment object. The attachment object includes an instrument panel reinforcement or a body panel. The wiring member is bonded and fixed to the attachment object by, for example, an adhesive tape. In addition, the wiring member may be fixed by locking a locking member provided on the wiring member to an object to be attached.

When the adhesive tape or the locking member is fixed to a member different from an attachment object to which the wiring member is to be attached, the wiring member is attached to the member different from the attachment object.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wiring member attachment structure for attaching a wiring member to an attachment object provided near an instrument panel is provided. The wiring member includes a linear transmission member that transmits electricity or light, and a covering member that covers the linear transmission member. The wiring member attachment structure includes a rail member provided on the attachment object and an insertion member that is provided on the covering member and inserted into the rail member. The wiring member is attached to the attachment object in a state in which the insertion member is inserted into the rail member.

Other features and aspects will be apparent from the following detailed description, the drawings, and the claims.

### BRIEF DESCRIPTION OF THE DRAWINGS

FIG. 1 is a diagram showing an attachment position of a wiring member.

FIG. 2 is a perspective view showing a configuration and an arrangement of the wiring member;

FIG. 3 is a side view illustrating an attachment structure for a wiring member according to a first embodiment.

FIG. 4 is a perspective view illustrating an attachment structure for a wiring member according to a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

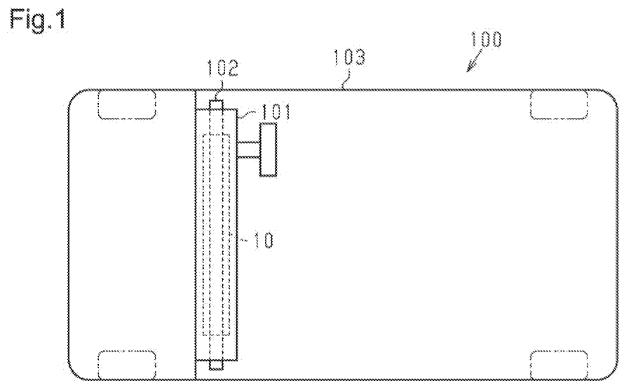

Hereinafter, an attachment structure for a wiring member according to a first embodiment will be described with reference to FIGS. 1 to 3.

Attachment Position of Wiring Member

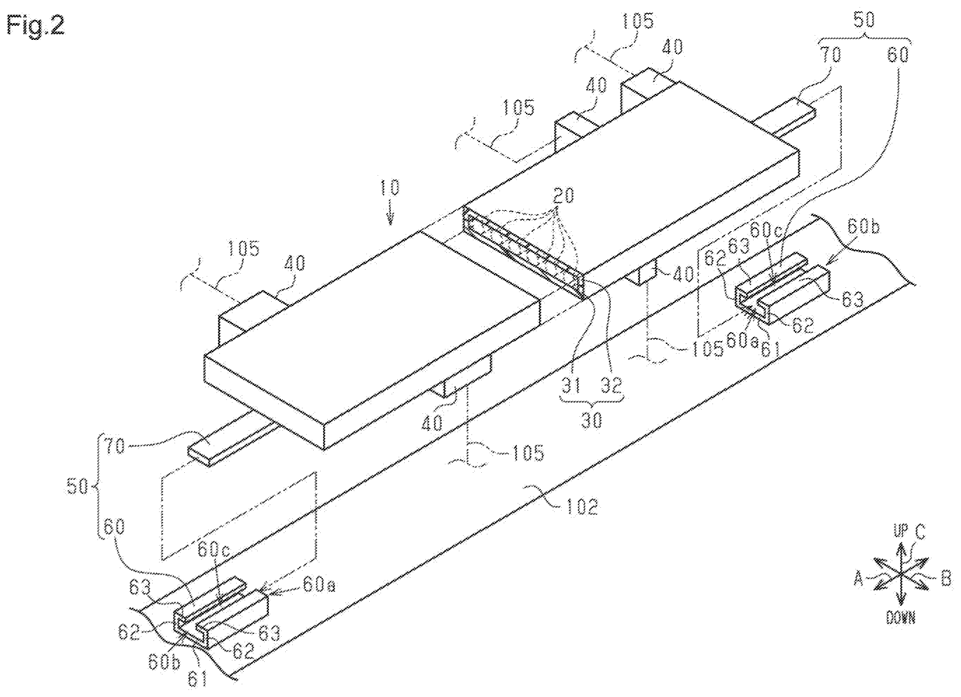

As illustrated in FIG. 1, a wiring member 10 is mounted on a vehicle 100. The wiring member 10 is attached to an instrument panel reinforcement 102 provided near an instrument panel 101. The instrument panel reinforcement 102 is provided on the back side of the instrument panel 101. The instrument panel reinforcement 102 is an object to which the wiring member 10 is attached. The instrument panel 101 and the instrument panel reinforcement 102 are components of a vehicle body 103. The instrument panel reinforcement 102 is a member that reinforces the vehicle body 103. The instrument panel reinforcement 102 is a rod-shaped member. The instrument panel reinforcement 102 extends in the left-right direction A illustrated in FIG. 2 of the vehicle 100. The opposite ends of the instrument panel reinforcement 102 are fixed to the front pillars (not illustrated). The wiring member 10 is electrically connected to an electric component (not illustrated) provided on the instrument panel 101. The wiring member 10 is a member that transmits electricity or light to the electric component. The wiring member 10 is a member that transmits electricity or light output from the electric component.

Configuration of Wiring Member

As illustrated in FIG. 2, the wiring member 10 has a flat shape. The long-side direction of the wiring member 10 agrees with the left-right direction A of the vehicle 100. The long-side direction of the wiring member 10 agrees with the longitudinal direction of the instrument panel reinforcement 102. The short-side direction of the wiring member 10 agrees with the front-rear direction B of the vehicle 100. The thickness direction of the wiring member 10 agrees with the vertical direction C.

The wiring member 10 includes linear transmission members 20, a covering member 30, and connectors 40. The linear transmission members 20 may be any linear members that transmit electricity or light. The linear transmission members 20 are, for example, general electric wires each having a core wire and a covering material covering the periphery of the core wire. The linear transmission members 20 may be, for example, shielded wires, enameled wires, nichrome wires, optical fibers, or the like. The linear transmission members 20 may be various signal lines or various power lines.

The covering member 30 includes a first sheet member 31 and a second sheet member 32. The first sheet member 31 and the second sheet member 32 are formed of a plastic. The first sheet member 31 and the second sheet member 32 are formed of, for example, vinyl chloride. The first sheet member 31 and the second sheet member 32 have flexibility. All the linear transmission members 20 are disposed on the first sheet member 31. In this state, all the linear transmission members 20 are covered with the second sheet member 32. The entire circumference of the outer edge of the first sheet member 31 and the entire circumference of the outer edge of the second sheet member 32 are welded to each other. In the present embodiment, the covering member 30 covers all the linear transmission members 20.

Connectors 40 are each electrically connected to a specified linear transmission member 20 provided in the covering member 30. Each connector 40 is a member that electrically connects the specified linear transmission member 20 to an electric component (not illustrated). Various cables 105 indicated by a long-dash double-short-dash lines in FIG. 2 are electrically connected to each connector 40. The connectors 40 are disposed so as not to interfere with the instrument panel reinforcement 102 when the wiring member 10 is attached to the instrument panel reinforcement 102.

Attachment Structure for Wiring Member

The attachment structure 50 for the wiring member 10 is a structure for attaching the wiring member 10 to the instrument panel reinforcement 102. The attachment structure 50 includes two rail members 60 and two insertion members 70. Each rail member 60 is provided on the instrument panel reinforcement 102. The insertion members 70 are provided at the opposite ends in the long-side direction of the wiring member 10. Each insertion member 70 has a long plate shape. Each insertion member 70 is provided on the first sheet member 31. Each insertion member 70 is provided on the covering member 30. The long-side direction of each insertion member 70 agrees with the long-side direction of the wiring member 10. The short-side direction of each insertion member 70 agrees with the short-side direction of the wiring member 10. The insertion members 70 protrude from the opposite ends of the wiring member 10 in the long-side direction.

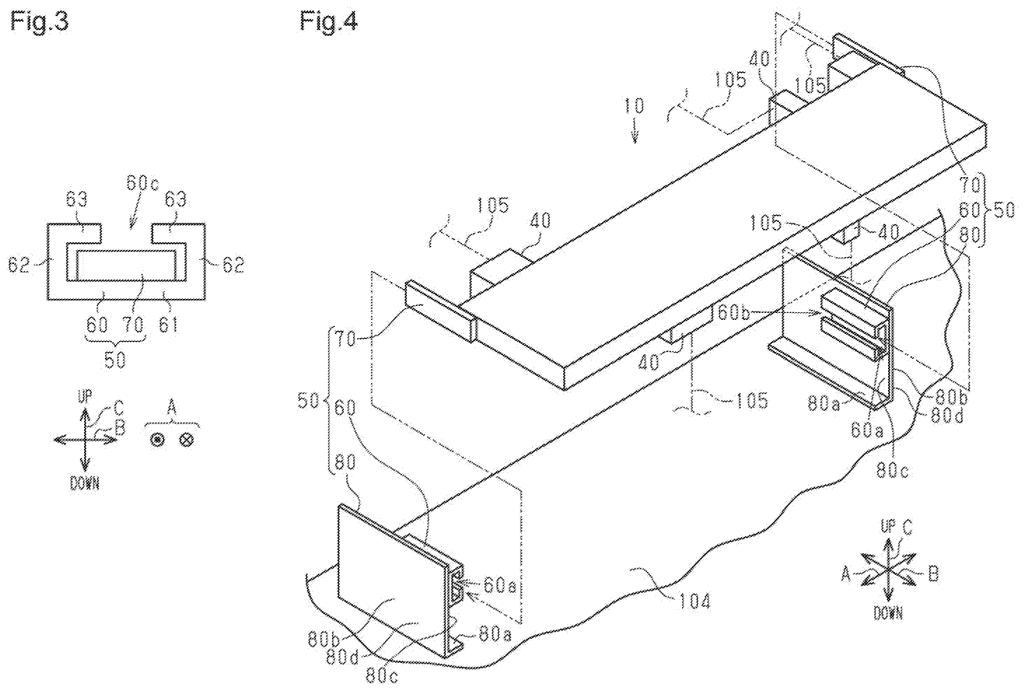

As illustrated in FIGS. 2 and 3, each rail member 60 includes a long plate-shaped base plate portion 61, two first plate portions 62, and two second plate portions 63. The long-side direction of the base plate portion 61 agrees with the left-right direction A, that is, the longitudinal direction of the instrument panel reinforcement 102. The short-side direction of the base plate portion 61 agrees with the front-rear direction B. The two first plate portions 62 extends upward from the opposite ends of the base plate portion 61 in the short-side direction. Each of the first plate portions 62 is provided over the entire length of the end of the base plate portion 61 in the short-side direction.

Each of the two second plate portions 63 extends from an end of each of the first plate portions 62, the end being on the side opposite from the base plate portion 61. Each of the second plate portions 63 is provided over the entire length of an end of each of the first plate portions 62, the end being on the side opposite from the base plate portion 61. Edges of the two second plate portions 63 face each other. The edges of the two second plate portions 63 are not in contact with each other. A space surrounded by the base plate portion 61, the two first plate portions 62, and the two second plate portions 63 is opened at the opposite ends of the each rail member 60 in the long-side direction. The space surrounded by the base plate portion 61, the two first plate portions 62, and the two second plate portions 63 is opened to the outside from the opening between the two second plate portions 63. The size of the space surrounded by the base plate portion 61, the two first plate portions 62, and the two second plate portions 63 is such a size that the insertion member 70 can be inserted.

As illustrated in FIG. 2, each rail member 60 has a first opening 60a, a second opening 60b, and a third opening 60c. The first opening 60a and the second opening 60b are opened at one and the other of the opposite ends of each rail member 60 in the long-side direction. The first opening 60a and the second opening 60b are formed by the base plate portion 61, the two first plate portions 62, and the two second plate portions 63, respectively. The first opening 60a and the second opening 60b open a space surrounded by the base plate portion 61, the two first plate portions 62, and the two second plate portions 63 to one and the other of the opposite ends of the rail member 60 in the long-side direction.

In the left-right direction A, that is, in the longitudinal direction of the instrument panel reinforcement 102, the first opening 60a of one rail member 60 and the first opening 60a of the other rail member 60 face each other with the above-described specified distance. The specified distance is larger than the length of the wiring member 10 in the long-side direction. The specified distance is smaller than the distance between the tips of the insertion members 70 protruding from the opposite ends of the wiring member 10 in the long-side direction.

The third opening 60c is opened between the edges of the two second plate portions 63 of each rail member 60. The third opening 60c is formed by the two second plate portions 63. The third opening 60c opens upward a space surrounded by the base plate portion 61, the two first plate portions 62, and the two second plate portions 63. The third opening 60c extends over the entire length of each rail member 60 in the long-side direction. The third opening 60c is continuous with the first opening 60a and the second opening 60b.

When the wiring member 10 is attached to the instrument panel reinforcement 102, the wiring member 10 is disposed above the instrument panel reinforcement 102. Then, the one insertion member 70 is inserted into the space of the rail member 60 from the first opening 60a of the one rail member 60. Next, the other insertion member 70 is inserted into the space of the rail member 60 from the first opening 60a of the other rail member 60. At this time, while bending the wiring member 10 in the vertical direction C, the other insertion member 70 is inserted into the other rail member 60 while aligning the tip of the other insertion member 70 with the first opening 60a of the other rail member 60. In this way, the two insertion members 70 is inserted into the corresponding rail members 60 of the two rail members 60. The insertion members 70 may be simultaneously inserted into the corresponding rail members 60.

As illustrated in FIG. 3, even when each insertion member 70 tries to move in the vertical direction C in a state in which the insertion members 70 are inserted into the respective rail members 60, the movement of each insertion member 70 is restricted by the base plate portion 61 or each second plate portion 63. Even when each insertion member 70 tries to move in the front-rear direction B in a state in which the insertion members 70 are inserted into the respective rail members 60, the movement of each insertion member 70 is restricted by the respective first plate portions 62. Unless the wiring member 10 is intentionally bent in the vertical direction C by the worker in a state in which the insertion members 70 are inserted into the respective rail members 60, the insertion members 70 do not come off from the respective rail members 60. Therefore, the wiring member 10 is attached to the instrument panel reinforcement 102 in a state in which the insertion member 70 is inserted into the rail member 60.

The work of attaching the wiring member 10 to the instrument panel reinforcement 102 is performed in a sub-line different from the production line of the vehicle 100. Then, the instrument panel module in which the wiring member 10 and the instrument panel reinforcement 102 are integrated by the attachment structure 50 is attached to the vehicle body 103 on the production line of the vehicle 100.

### Operation of Present Embodiment

The operation of the present embodiment will be described.

Since the rail member 60 is provided on the instrument panel reinforcement 102, an object to which the wiring member 10 is attached is clarified by the rail member 60. The wiring member 10 is attached to the instrument panel reinforcement 102 by inserting the insertion member 70 into the rail member 60. This prevents the wiring member 10 from being attached to a member different from the instrument panel reinforcement 102.

In addition, a case will now be described in which the attachment structure 50 is omitted. In this case, when the wiring member 10 is attached to the instrument panel reinforcement 102, the wiring member 10 is disposed above the instrument panel reinforcement 102. When viewed from above by the worker, at least part of the instrument panel reinforcement 102 is hidden by the wiring member 10. For this reason, there is a concern that it is difficult to attach the wiring member 10 to the instrument panel reinforcement 102.

In the attachment structure 50 of the present embodiment, the distance between the two rail members 60 is larger than the length of the wiring member 10 in the long-side direction. Therefore, when viewed from above by the worker, the rail member 60 is not covered by the wiring member 10, and thus is disposed at a position visible to the worker. That is, even when the instrument panel reinforcement 102 is difficult to see due to the wiring member 10, the rail member 60 serves as a mark indicating an attachment position of the wiring member 10 with respect to the instrument panel reinforcement 102. The process of inserting the one insertion member 70 into the one rail member 60 is visually observed from the third opening 60c of the one rail member 60. The process of inserting the other insertion member 70 into the other rail member 60 is visually observed from the third opening 60c of the other rail member 60. That is, the worker can easily view the process until the wiring member 10 is attached to the instrument panel reinforcement 102. This improves attachment work efficiency of the wiring member 10 to the instrument panel reinforcement 102.

### Advantages of Present Embodiment

Advantages of the present embodiment will be described.

(1-1) Since the rail member 60 is provided on the instrument panel reinforcement 102, an object to which the wiring member 10 is attached is clarified by the rail member 60. The wiring member 10 is attached to the instrument panel reinforcement 102 by inserting the insertion members 70 into the corresponding rail members 60. Therefore, it is possible to prevent the wiring member 10 from being attached to a member different from the instrument panel reinforcement 102.

(1-2) The object to which the wiring member 10 is attached is the instrument panel reinforcement 102. Therefore, the instrument panel reinforcement 102 can be used not only as a member for reinforcing the vehicle body 103 but also as a member for routing the wiring member 10 in the instrument panel 101. Therefore, the wiring member 10 can be routed by the existing components of the vehicle body 103 without adopting another member for routing the wiring member 10.

(1-3) Since each of the rail members 60 has the third opening 60c, the worker can view the insertion of the insertion members 70 into the respective rail members 60. Therefore, the worker can reliably check whether the wiring member 10 is attached to the instrument panel reinforcement 102.

(1-4) On the other hand, as long as the tip of each insertion member 70 is aligned with the first opening 60a of the corresponding rail member 60, the worker does not need to view the insertion state of each insertion member 70 into the corresponding rail member 60 through the third opening 60c. That is, as long as the tip of each insertion member 70 is aligned with the first opening 60a of the corresponding rail member 60, the worker can attach the wiring member 10 to the instrument panel reinforcement 102 only by inserting the insertion members 70 into the respective rail members 60 without visual observation.

(1-5) The instrument panel module in which the wiring member 10 and the instrument panel reinforcement 102 are integrated by the attachment structure 50 is attached to the vehicle body 103 on a production line of the vehicle 100. Therefore, the production efficiency of the vehicle 100 is improved as compared with the case in which the wiring member 10 is attached to the instrument panel reinforcement 102 in the production line of the vehicle 100.

The wiring member 10 is attached to the instrument panel reinforcement 102 in a sub-line different from the production line of the vehicle 100. Therefore, the wiring member 10 is more unlikely to be attached to a member different from the instrument panel reinforcement 102 than when the wiring member 10 is attached to the instrument panel reinforcement 102 in the production line of the vehicle 100.

### Second Embodiment

Hereinafter, an attachment structure for a wiring member according to a second embodiment will be described with reference to FIG. 4. The present embodiment is mainly different from the first embodiment in that the object to which the wiring member is attached is changed. This point will be mainly described, and the same components as those of the first embodiment will be denoted by the same reference numerals, and detailed description of the components will be omitted.

Attachment Structure for Wiring Member

As illustrated in FIG. 4, the attachment structure 50 further includes two brackets 80. Each bracket 80 is an object to which the wiring member 10 is attached. Each bracket 80 has a plate shape. The vehicle body 103 includes a cowl top panel 104. The cowl top panel 104 is a component of the vehicle body 103. The cowl top panel 104 is disposed on the back side of the instrument panel 101. The cowl top panel 104 is positioned in front of the instrument panel 101. Each bracket 80 is attached to the cowl top panel 104. Each bracket 80 is attached to a component of the vehicle body 103 illustrated in FIG. 1. In the present embodiment, each bracket 80 is a member different from a component of the vehicle body 103.

Each bracket 80 includes a support plate portion 80a and an extension plate portion 80b. The support plate portion 80a is attached to the cowl top panel 104. The extension plate portion 80b extends upward from the support plate portion 80a. The extension plate portion 80b has a thickness in the left-right direction A. The extension plate portion 80b has a first face 80c and a second face 80d. The first face 80c and the second face 80d are planes located in the thickness direction of the extension plate portion 80b.

The two brackets 80 are disposed such that the extension plate portion 80b face each other in the left-right direction A. Specifically, the two brackets 80 are disposed such that the first faces 80c of the extension plate portion 80b face each other in the left-right direction A. In this state, the distance between the first face 80c of the extension plate portion 80b of the one bracket 80 and the first face 80c of the extension plate portion 80b of the other bracket 80 is longer than the length of the wiring member 10 in the long-side direction. A rail member 60 is provided on the first face 80c of each bracket 80. The base plate portion 61 of each rail member 60 is fixed to the first face 80c. The first opening 60a of each rail member 60 opens forward. The second opening 60b of each of the rail members 60 opens rearward. The third openings 60c of the respective rail members 60 face each other.

The insertion members 70 are provided at the opposite ends in the long-side direction of the wiring member 10. The long-side direction of each insertion member 70 agrees with the short-side direction of the wiring member 10. The short-side direction of each insertion member 70 agrees with the vertical direction C. Each insertion member 70 protrudes from one of the opposite ends of the wiring member 10 in the short-side direction. The distance between the one insertion member 70 and the other insertion member 70 is the same as the distance between the first opening 60a of the one rail member 60 and the first opening 60a of the other rail member 60.

When the wiring member 10 is attached to each bracket 80, the tip of each insertion member 70 faces the first opening 60a of each rail member 60 in the front-rear direction B. Then, the wiring member 10 is moved toward the space between the two brackets 80. As a result, each insertion member 70 is inserted into the space of the corresponding rail member 60 from the first opening 60a. In a state in which the insertion member 70 is inserted into the rail member 60, the wiring member 10 is attached to the two brackets 80.

### Operation of Present Embodiment

The operation of the present embodiment will be described.

Since the rail member 60 is provided on each bracket 80, an object to which the wiring member 10 is attached is clarified by the rail member 60. By inserting the insertion members 70 into the corresponding rail members 60, the wiring member 10 is attached to the two brackets 80. Therefore, the wiring member 10 is prevented from being attached to a member different from the two brackets 80.

### Advantages of Present Embodiment

Advantages of the present embodiment will be described.

(2-1) Since the rail member 60 is provided on each bracket 80, an object to which the wiring member 10 is attached is clarified by the rail member 60. By inserting the insertion members 70 into the corresponding rail members 60, the wiring member 10 is attached to the two brackets 80. Therefore, it is possible to prevent the wiring member 10 from being attached to a member different from the two brackets 80.

(2-2) The brackets 80 allows the rail member 60 and the insertion member 70 to be disposed at positions avoiding components provided around the instrument panel 101. Therefore, even when a component or the like is disposed around the instrument panel 101, the arrangement of the wiring member 10 can be appropriately changed by the bracket 80.

(2-3) According to the present embodiment, the wiring member 10 can be attached to each bracket 80 without bending the wiring member 10 in the vertical direction C. That is, when the wiring member 10 is attached, stress is not generated in the linear transmission member 20 in the wiring member 10. Therefore, disconnection of the linear transmission member 20 does not occur when the wiring member 10 is attached to each bracket 80.

Modifications

Each of the above embodiments can be modified as follows. The above embodiments and the following modification examples can be implemented in combination with each other within a range not technically contradictory.

In each of the above embodiments, the number of the rail members 60 may be one or more than two. Then, the number of the insertion members 70 is changed depending on the number of the rail members 60. The number of the rail members 60 and the number of the insertion members 70 are preferably set after checking in advance that the wiring member 10 is stably attached to the attachment object.

In each of the above embodiments, each first plate portion 62 does not necessarily need to be provided over the entire length of the end of the base plate portion 61 in the short-side direction. Even when such a change is made, it is sufficient that the insertion member 70 is inserted into a space surrounded by the base plate portion 61, each of the first plate portions 62, and each of the second plate portions 63.

In each of the above embodiments, instead of the two second plate portions 63, a third plate portion connecting ends of the two first plate portions 62, the ends being opposite to the base plate portion 61, may be used. That is, in the rail member 60, the third opening 60c may be omitted.

In each of the above embodiments, the rail member 60 has the first opening 60a, and the second opening 60b and the third opening 60c may be omitted.

In each of the above embodiments, the shapes of the rail member 60 and the insertion member 70 may be changed so that multiple balls can be interposed between the rail member 60 and the insertion member 70. That is, the ball slide rail may be formed by the rail member 60, the insertion member 70, and the balls. The shape of the rail member 60 may be appropriately changed as long as the insertion member 70 can be inserted.

In each of the above embodiments, for example, the first opening 60a of each rail member 60 may be changed to face upward. The manner of attachment of each insertion member 70 to the wiring member 10 is appropriately changed so that the insertion member 70 can be inserted into the first opening 60a of each rail member 60. The insertion direction of the insertion member 70 with respect to the rail member 60 may be appropriately changed. That is, the insertion direction of the insertion member 70 with respect to the rail member 60 can be appropriately changed according to the layout of the production line of the vehicle 100 and the position of the worker. Therefore, the routing work of the wiring member 10 in the production of the vehicle 100 can be optimized.

In each of the above embodiments, when the linear transmission member 20 is, for example, a general electric wire, the covering member 30 does not necessarily need to cover the entire linear transmission member 20. The covering member 30 is only required to be able to bring all the linear transmission members 20 close to each other. However, when the linear transmission member 20 is a shielded wire, an enameled wire, a nichrome wire, an optical fiber, or the like, the covering member 30 preferably covers the entire linear transmission member 20.

In each of the above embodiments, the wiring member 10 does not necessarily need to have a flat shape. The shape of the wiring member 10 is appropriately changed according to the number of linear transmission members 20 and the configuration of the covering member 30.

In the first embodiment, the wiring member 10 may be attached to the instrument panel reinforcement 102 in a production line of the vehicle 100.

In the first embodiment, each rail member 60 is provided above the instrument panel reinforcement 102, but the present invention is not limited thereto. Each rail member 60 may be provided, for example, in front of or behind the instrument panel reinforcement 102.

In the second embodiment, the shape of the bracket 80 may be appropriately changed. The shape of the bracket 80 may be appropriately changed as long as the rail member 60 can be attached.

In the second embodiment, the bracket 80 may be attached to, for example, the instrument panel reinforcement 102 or a front pillar (not illustrated). The bracket 80 may be attached to a roof panel. It is sufficient that the bracket 80 is attached to a component of the vehicle body 103.

In the second embodiment, the number of the brackets 80 may be more than two or may be one.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A wiring member attachment structure for attaching a wiring member to an attachment object provided near an instrument panel, the wiring member including a linear transmission member that transmits electricity or light, and a covering member that covers the linear transmission member, the wiring member attachment structure comprising:
a rail member provided on the attachment object; and
an insertion member that is provided on the covering member and inserted into the rail member,
wherein the wiring member is attached to the attachment object in a state in which the insertion member is inserted into the rail member.

2. The wiring member attachment structure according to claim 1, wherein the attachment object includes an instrument panel reinforcement.

3. The wiring member attachment structure according to claim 1, further comprising a bracket that is a member different from a component of a vehicle body and serves as the attachment object,
wherein the bracket is attached to the component.

4. The wiring member attachment structure according to claim 2, wherein
the rail member is one of two rail members,
the insertion member is one of two insertion members,
each of the two rail members has a space opened at opposite ends of the rail member in a longitudinal direction,
each of the two insertion members has a long plate shape, and
the wiring member is attached to the instrument panel reinforcement when each of the two insertion members is inserted from an opening of a corresponding rail member of the two rail members into the space of the corresponding rail member.

5. The wiring member attachment structure according to claim 4, wherein
the rail member includes:
a long plate-shaped base plate portion extending in the longitudinal direction of the rail member;
two first plate portions extending from opposite ends of the base plate portion in a short-side direction; and
two second plate portions each of which extends from an end of each of the two first plate portions, the end being on a side opposite to the base plate portion, and tips of the two second plate portions facing each other and being not in contact with each other,
the space is a space surrounded by the base plate portion, the two first plate portions, and the two second plate portions, and
an opening that opens the space is formed by the two second plate portions.

6. The wiring member attachment structure according to claim 4, wherein a distance between the two rail members is larger than a length of the wiring member in a long-side direction.
